(19) United States
(12) Patent Application Publication
(10) Pub. No.: US 2026/0362184 A1
(43) Pub. Date: Nov. 12, 2026

(54) TECHNOLOGIES FOR SYNCHRONIZATION SIGNAL BLOCK MEASUREMENT

(71) Applicant: Apple Inc., Cupertino, CA (US)

(72) Inventors: Peng Cheng, Beijing (CN); Haijing Hu, Cupertino, CA (US); Qiming Li, Beijing (CN); Jie Cui, San Jose, CA (US); Dan Wu, Beijing (CN); Seung Hee Han, San Jose, CA (US)

(73) Assignee: Apple Inc., Cupertino, CA (US)

(21) Appl. No.: 19/671,081

(22) Filed: May 7, 2026

(30) Foreign Application Priority Data
May 7, 2025 (WO) PCT/CN2025/093171

(51) Int. Cl. H04W 24/08; H04L 5/00

(52) U.S. Cl. CPC H04W 24/08; H04L 5/005

(57) ABSTRACT

The present application relates to devices and components, including apparatus, systems, and methods for measurements of always-on (AO) and on-demand (OD) synchronization signal block (SSB).

### CROSS-REFERENCE TO RELATED APPLICATION

This application claims priority to PCT Application PCT/CN2025/093171, filed May 7, 2025, which is hereby incorporated by reference in its entirety.

### TECHNICAL FIELD

This application relates generally to communication networks and, in particular, to measurements of always-on (AO) and on-demand (OD) synchronization signal block (SSB).

### BACKGROUND

Third Generation Partnership Project (3GPP) Technical Specifications (TSs) define standards for wireless networks. These TSs describe aspects related to user plane and control plane signaling over the networks.

### BRIEF DESCRIPTION OF THE DRAWINGS

FIG. 1 illustrates a network environment in accordance with some embodiments.

FIG. 2 illustrates SSB transmissions in accordance with some embodiments.

FIG. 3 illustrates an operation flow/algorithmic structure in accordance with some embodiments.

FIG. 4 illustrates control elements in accordance with some embodiments.

FIG. 5 illustrates a signaling diagram in accordance with some embodiments.

FIG. 6 illustrates another operation flow/algorithmic structure in accordance with some embodiments.

FIG. 7 illustrates another operation flow/algorithmic structure in accordance with some embodiments.

FIG. 8 illustrates an operation flow/algorithmic structure in accordance with some embodiments.

FIG. 9 illustrates a user equipment in accordance with some embodiments.

FIG. 10 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry,” as used herein, refers to, is part of, or includes hardware components that are configured to provide the described functionality. The hardware components may include an electronic circuit, a logic circuit, a processor (shared, dedicated, or group) or memory (shared, dedicated, or group), an application-specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry,” as used herein, refers to, is part of, or includes circuitry capable of sequentially and automatically carrying out a sequence of arithmetic or logical operations, recording, storing, or transferring digital data. The term “processor circuitry” may refer to an application processor, baseband processor, central processing unit (CPU), graphics processing unit, single-core processor, dual-core processor, triple-core processor, quad-core processor, or any other device capable of executing or otherwise operating computer-executable instructions, such as program code, software modules, or functional processes.

The term “interface circuitry,” as used herein, refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component or asset within a computing or network environment, or a physical or virtual component within, accessible by, or available to a device or component. Resources could include, but are not limited to, memory space/usage, processor/CPU time, processor/CPU usage, processor and accelerator loads, hardware time or usage, electrical power, input/output operations, ports or network sockets, channel/link allocations, throughput, or workload units. A “hardware resource” may refer to compute, storage, or networking resources provided by physical hardware elements. A “virtualized resource” may refer to compute, storage, or networking resources provided by virtualization infrastructure to an application, device, or system. The term “communication resource” may refer to resources that are accessible by, or available to, computer devices/systems for transferring information over a channel of a communication network. For example, communication resources may include, but are not limited to, time/frequency resources, code resources, modulation resources, etc. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any transmission medium, either tangible or intangible, that is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, or a virtualized network function.

The term “information element” refers to a structural element containing one or more fields. The term “field” refers to individual contents of an information element or a data element that contains content. An information element may include one or more additional information elements.

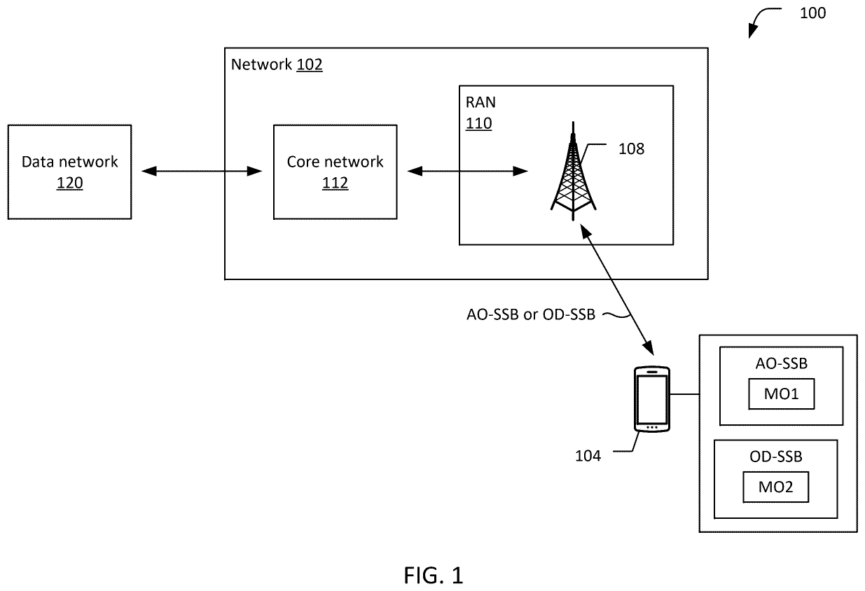

FIG. 1 illustrates a network environment 100 in accordance with some embodiments. The network environment 100 may include a UE 104 communicatively coupled with a base station 108 of a radio access network (RAN) 110. The UE 104 and the base station 108 may communicate over air interfaces compatible with 3GPP TSs, such as those that define a Fifth Generation (5G) new radio (NR) system or a later system. The base station 108 may provide user plane and control plane protocol terminations toward the UE 104.

Operations described herein as associated with devices of the network environment 100 (for example, the UE 104 and the base station 108) may be fully, substantially, or partially performed by processor circuitry of the device.

The network environment 100 may further include a core network 112. For example, the core network 112 may comprise a 5th Generation Core network (5GC) or a later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions. The core network 112, RAN 110, and RAN 110 may collectively be referred to as network 102.

The network environment 100 may further include a data network 120. Data network 120 may include a system of interconnected nodes that facilitate data transmission between UE 104 and various application servers and other service providers. The base station 108 and the core network 112 may route application data between the UE 104 and external data network 120 or application servers. These application servers host web applications, cloud storage, and multimedia streaming services, which communicate with the UE 104 via standardized protocols and interfaces defined by 3GPP, ensuring secure and efficient data exchange.

The initial cell with which the UE 104 establishes its connection during the initial connection establishment procedure may be referred to as the primary cell (PCell). A secondary cell (SCell) may be a cell in addition to the PCell that can be configured after the initial connection is established. In carrier aggregation scenarios, SCell is aggregated with the PCell to increase overall bandwidth and improve data rates. In some instances, SCell may be a neighbor cell that the UE monitors. In some embodiments, PCell and SCell may be provided by different base stations.

The base station 108 may transmit several reference signals. One such signal may be the primary synchronization signal (PSS). The UE 104 may obtain the cell identity from the PSS. Another reference signal may be a secondary synchronization signal (SSS). The UE 104 may obtain frame timing from SSS. Once the UE 104 is synchronized with the cell, the UE 104 may receive system information, including master information block (MIB) and system information blocks (SIBs). The base station 108 may transmit MIB and SIBs on a physical broadcast channel (PBCH). The collection of PSS, SSS, and PBCH may be referred to as synchronization signal block (SSB). A cell may include one or more SSBs. Each SSB in a cell may be associated with a beam. The network 102, e.g., RAN 110 or the base station 108, may configure, activate, or deactivate the SSBs.

The PCell may periodically transmit SSBs. The periodic SSBs may be referred to as Type-1 SSBs or always-on (AO)-SSBs. The SCell may support AO-SSBs (Type-1 SSB). In some instances, the SCell may support AO-SSB with a larger periodicity, e.g., to save energy. Alternatively, the SCell may also support on-demand SSB transmissions (e.g., aperiodic or semi-persistent SSB transmissions, which may also be called Type-2 SSBs or on-demand (OD)-SSBs). An aperiodic OD-SSB transmission may be transmitted in one or more SSB transmission occasions. A semi-persistent OD-SSB transmission may be similar to an aperiodic OD-SSB transmission. A semi-persistent OD-SSB may be started or triggered when the UE 104 receives an activation command from base station 108 and may be stopped when the UE 104 receives a deactivation command or detects an implicit deactivation condition.

In some embodiments, AO-SSB or OD-SSB may be configured and used on SCell. The AO-SSB or OD-SSB may be used to perform measurements for cell selection, reselection, or layer 3 (L3) measurement to trigger SCell activation or deactivation. L3 measurements may be used for mobility management, radio resource management (RRM), quality of service (QoS) optimization, network planning optimization, or inter-radio access technology (RAT) coordination. L3 measurements may include reference signal receive power (RSRP), reference signal received quality (RSRQ), or signal-to-interference and noise ratio (SINR).

The BS 108 may configure an AO-SSB and an OD-SSB for the UE 104. AO-SSB provides periodic synchronization signals that are always available to UE 104, enabling initial access, beam management, and mobility-related operations. In contrast, OD-SSB is configured to transmit synchronization signals only when needed, such as during specific events or conditions like secondary cell (SCell) activation or measurement requests. AO-SSB and OD-SSB configurations may include parameters such as transmission periodicity, frequency allocation, and beamforming information, which allow BS 108 to manage synchronization performance and resource utilization across the network. For example, BS 108 may transmit a medium access control (MAC) control element (CE) to UE 104, wherein the MAC CE specifies activation or deactivation of the OD-SSB for one or more serving cells. The configuration of AO-SSB may enable continuous synchronization, while the configuration of OD-SSB may provide flexibility to reduce signaling overhead and power consumption in scenarios where continuous synchronization is unnecessary.

The network 102 may configure the UE 104 with a measurement object (MO) (e.g., MO1 and MO2). The MO configuration may specify the radio frequency (RF) resources and criteria for UE 104 to perform measurements on serving cells or neighbor cells. MOs may be configured by BS 108 through higher-layer signaling, such as radio resource control (RRC) messages. The MO configuration may include parameters such as the carrier frequency, reference signal type (e.g., SSB or channel state information (CSI)-reference signal (RS)), measurement bandwidth, and reporting thresholds. These parameters may allow UE 104 to perform measurements for purposes such as mobility management, handover, and interference mitigation.

MOs support functionalities that enable UE 104 to report measurement results to BS 108 or network 102 for decision-making processes. For example, MOs may define event-triggered reporting (e.g., when signal quality crosses a threshold) or periodic reporting (e.g., at predefined intervals). Additionally, MOs may specify the type of measurement to be performed, such as RSRP, RSRQ, or SINR. This may allow BS 108 to manage the use of radio resources and may provide seamless connectivity for UE 104.

The AO-SSB and OD-SSB configurations in UE 104 may be associated with respective MOs to facilitate synchronization and measurements. Specifically, the configuration of AO-SSB is associated with a measurement object (MO1), while the configuration of OD-SSB is associated with a separate measurement object (MO2). MO1 and MO2 are provisioned by BS 108 via RRC signaling and define the measurement parameters for AO-SSB and OD-SSB, respectively. For example, MO1 may specify periodic measurements of synchronization signals transmitted by AO-SSB to enable continuous monitoring of the serving cell and neighbor cells. MO2 may define event-triggered measurements of OD-SSB to support specific use cases, such as secondary cell activation or inter-frequency handover.

Through the association between AO-SSB and MO1, UE 104 can perform measurements that allow BS 108 to monitor the quality of the serving cell and manage mobility. Similarly, the association between OD-SSB and MO2 enables event-driven measurements that reduce signaling overhead and power consumption when continuous monitoring is unnecessary. For instance, BS 108 may activate OD-SSB on a secondary cell and configure MO2 to allow UE 104 to measure the secondary cell's signal quality before activating it for data transmission. This coordinated use of AO-SSB, OD-SSB, and their associated MOs provides a flexible framework for synchronization and measurement.

In legacy solutions, where an AO-SSB and an OD-SSB are configured on different frequencies, the behavior of the UE 104 during L3 measurements may become ambiguous. L3 measurements allow UE 104 to evaluate the quality of radio links and report measurement results to BS 108 or network 102. However, in cases where AO-SSB and OD-SSB operate on different frequencies, there is no clear mechanism for UE 104 to determine whether it should prioritize measurements associated with AO-SSB or OD-SSB. This lack of clarity may introduce challenges in legacy solutions, as UE 104 may default to measuring AO-SSB due to its periodic nature, even when OD-SSB becomes activated for specific events, such as secondary cell activation or inter-frequency mobility. Without explicit signaling mechanisms to dynamically switch measurement focus between AO-SSB and OD-SSB, UE 104 may perform suboptimal measurements, impacting mobility management, secondary cell activation, and inter-cell coordination.

In legacy solutions, when AO-SSB and OD-SSB are configured on different frequencies, UE 104 may face uncertainty in determining whether a neighbor cell measurement corresponds to intra-frequency or inter-frequency conditions. Intra-frequency measurements involve neighbor cells operating on the same frequency as the serving cell, while inter-frequency measurements involve different frequencies. Accurate classification of measurement types is desired for mobility management and handover operations.

In scenarios involving AO-SSB and OD-SSB on different frequencies, legacy solutions lack robust signaling mechanisms to dynamically indicate whether the frequency of AO-SSB or OD-SSB should be used as the reference for neighbor cell comparison. This ambiguity can result in UE 104 misclassifying neighbor cell measurements, leading to degraded mobility performance, inefficient handover decisions, and increased signaling overhead. For example, if OD-SSB becomes activated, UE 104 may need to switch its reference from AO-SSB to OD-SSB dynamically, but the absence of clear signaling frameworks to facilitate this transition may result in delays or incorrect measurement classifications.

In some embodiments, UE 104 may select an MO associated with AO-SSB or OD-SSB based on the activation state of OD-SSB. For example, if OD-SSB is not activated, UE 104 may select the MO associated with AO-SSB for L3 measurements. In some embodiments, if OD-SSB is activated, UE 104 may switch to selecting the MO associated with OD-SSB for L3 measurements. This selection mechanism may allow the UE 104 to dynamically adapt its measurement behavior depending on the state of OD-SSB, addressing the ambiguity described earlier.

The UE 104 may use the serving cell MO (e.g., RRC configuration parameter servingCellMO) associated with AO-SSB when OD-SSB is not activated and may switch to the serving cell MO (e.g., servingCellMO) associated with OD-SSB when OD-SSB is activated. In some instances, multiple OD-SSBs on different frequencies may be transmitted for a single SCell. When all OD-SSBs are explicitly deactivated, e.g., via MAC-CE, or implicitly deactivated, e.g., after N transmissions, the UE 104 may use the serving cell MO (e.g., servingCellMO) associated with AO-SSB to perform serving cell measurements. When network 102 activates an OD-SSB, e.g., via MAC-CE, the UE 104 may switch to or select the serving cell MO (e.g., servingCellMO) associated with the activated OD-SSB to perform serving cell measurements.

In some embodiments, BS 108 may transmit a medium access control (MAC) control element (CE) to UE 104 to indicate which serving cell MO should be measured. The MAC CE may include a bitmap field identifying the serving cell to be measured, allowing UE 104 to identify the MO associated with the specified serving cell for measurements. This signaling mechanism provides BS 108 with the ability to dynamically configure UE 104′s measurement focus, ensuring proper prioritization of AO-SSB or OD-SSB-associated MOs in scenarios involving different frequencies.

The network 102 may introduce a separate MAC-CE to indicate to UE 104 which serving cell MO to use for measurements. Even if OD-SSB is activated, network 102 may prefer UE 104 to continue L3 measurements based on AO-SSB. The MAC-CE may include a new LCID or eLCID. Each bit in the bitmap field, Bi, may correspond to an SCell with SCellIndex i. Bi set to 1 may indicate serving cell MO (e.g., servingCellMO) of OD-SSB, and Bi set to 0 may indicate serving cell MO (e.g., servingCellMO) of AO-SSB. If no SCell is configured, UE 104 may ignore the bit. The reserved bit, R, may be set to 0.

In some embodiments, UE 104 may autonomously determine which serving cell MO to measure based on implementation-specific criteria. For example, UE 104 may take into account the frequency configuration of AO-SSB and OD-SSB, the activation state of OD-SSB, or other network conditions to decide whether to prioritize measurements associated with AO-SSB or OD-SSB. This implementation provides flexibility for UE 104 to optimize its measurement behavior without requiring explicit signaling from BS 108.

The UE 104 may use the serving cell MO associated with AO-SSB when OD-SSB is not activated. Otherwise, it may be up to UE implementation to decide which serving cell MO (e.g., servingCellMO) to measure. This approach may provide the greatest flexibility for UE 104.

In some embodiments, UE 104 may determine whether a neighbor cell L3measurement is intra-frequency or inter-frequency by comparing the frequency of the neighbor cell SSB with the frequency of its serving cell MO (e.g., servingCellMO). If the frequencies are the same, the measurement may be classified as intra-frequency. If the frequencies differ, the measurement may be classified as inter-frequency. However, in scenarios where there are two serving cell MOs for the same SCell, UE 104 may encounter ambiguity in determining whether the neighbor cell measurement is intra-frequency or inter-frequency.

In some embodiments, the UE 104 may determine the measurement type based on the SSB frequency in the serving cell MO (e.g., servingCellMO) being used for serving cell measurement. The serving cell MO may be identified as described above. For example, if UE 104 selects the MO associated with AO-SSB as the reference MO, the frequency of AO-SSB may be used to classify neighbor cell measurements. Similarly, if UE 104 selects the MO associated with OD-SSB as the reference MO, the frequency of OD-SSB may be used for classification. This mechanism enables UE 104 to accurately distinguish between intra-frequency and inter-frequency measurements in scenarios where AO-SSB and OD-SSB operate on different frequencies.

In some embodiments, the UE 104 may determine the measurement type based on the SSB frequency in the configured serving cell MO of AO-SSB. The assumption may be that UE 104 only occasionally performs L3 measurements towards OD-SSB.

In some embodiments, the UE 104 may determine the measurement type based on the SSB frequency in the configured serving cell MO of OD-SSB. The assumption may be that L3 measurements towards OD-SSB are more accurate.

In some embodiments, the network 102 may introduce another IE in ServingCellConfig to indicate which serving cell MO (e.g., servingCellMO) is used to determine whether a neighbor cell measurement is intra-frequency or inter-frequency.

In some embodiments, if neither AO-SSB nor OD-SSB is transmitted, UE 104 may regard all neighbor cell measurements as inter-frequency measurements.

In some embodiments, BS 108 may configure UE 104 with an information element (IE) to indicate whether the MO associated with AO-SSB or the MO associated with OD-SSB should be used as the reference MO for neighbor cell measurement classification. The IE may include frequency-specific information, allowing UE 104 to dynamically switch between AO-SSB and OD-SSB frequencies as the reference for determining intra-frequency or inter-frequency measurement types. This signaling mechanism addresses the ambiguity in legacy solutions and ensures accurate measurement classification in scenarios involving multiple frequency configurations.

In some embodiments, the network 102 may resolve ambiguity in serving cell MO selection by configuring UE 104 to use the MO associated with AO-SSB as the default reference MO. For example, when OD-SSB is not activated, BS 108 may instruct UE 104 to use AO-SSB-associated MO for measurements. This default behavior provides a baseline for measurement operations and simplifies UE 104's decision-making process in scenarios where AO-SSB and OD-SSB operate on different frequencies.

In some embodiments, UE 104 may dynamically switch between AO-SSB-associated MO and OD-SSB-associated MO based on conditions specified by BS 108 or network 102. For example, BS 108 may transmit an activation command to trigger OD-SSB transmission, followed by the configuration of MO associated with OD-SSB for measurements. Similarly, BS 108 may transmit a deactivation command or configure implicit deactivation conditions to revert measurement focus to AO-SSB-associated MO. This dynamic switching mechanism enables seamless coordination of measurement operations across serving cells and neighbor cells.

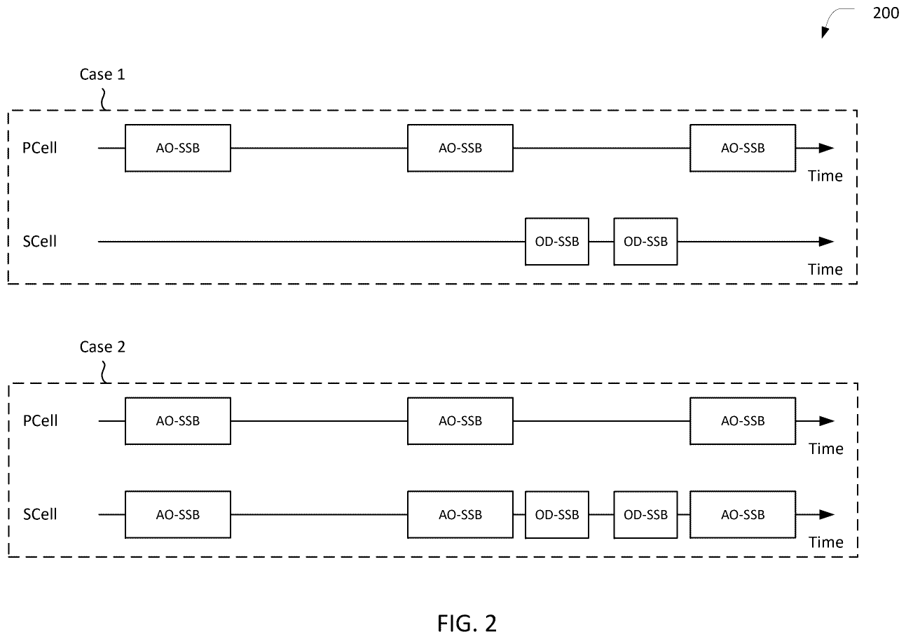

FIG. 2 illustrates SSB schedule 200 in accordance with some embodiments. SSB schedule 200 includes two cases demonstrating different resource allocations for the transmission of AO-SSB sand OD-SSBs.

In some embodiments, a serving cell may support two distinct cases for SSB transmission. In the first case, referred to as Case 1, AO-SSBs are transmitted on the PCell, while the SCell may only transmit OD-SSBs. OD-SSBs in Case 1 may be triggered by specific events, such as SCell activation or measurement requests, reducing signaling overhead and energy consumption on the SCell. For example, BS 108 may transmit a MAC-CE to UE 104 to activate OD-SSB transmission for the SCell. The MAC-CE may include parameters specifying the transmission occasions or conditions under which OD-SSBs are transmitted. This case is particularly advantageous for scenarios where the SCell is used intermittently or where resource efficiency is prioritized.

In some embodiments, the L3 measurement in Case 1 is simplified by the absence of AO-SSBs on the SCell. In this case, UE 104 may perform measurements only when OD-SSBs are activated. When OD-SSB transmission is deactivated, UE 104 may not perform SSB measurements. This approach may eliminate ambiguity, as UE 104 expects to measure SSBs exclusively during the activation of OD-SSB transmission.

The activation and deactivation of OD-SSB transmission may be indicated by a MAC-CE or higher-layer signaling, such as RRC messages. For RRC-based activation and deactivation of OD-SSB, the network 102 may de-configure the serving cell MO via RRC when OD-SSB is deactivated, e.g., the servingCellMO parameter in RRC configuration. For MAC-CE-based activation and deactivation, UE 104 may start L3 measurements toward the activated OD-SSB based on the configured serving cell MO (e.g., servingCellMO configuration) upon reception of the activation MAC-CE. Similarly, UE 104 may stop L3 measurements when it determines that OD-SSB is deactivated, either implicitly or explicitly. In this implementation, UE 104 may dynamically adapt its measurement operations based on the signaling received from BS 108.

The UE may, whenever it has a measurement configuration (measConfig), perform RSRP and RSRQ measurements for each serving cell for which a serving cell MO (servingCellMO) is configured. The serving cell MO (e.g., servingCellMO) provides an ID of the MO configuration (measObject) associated with the serving cell. If the reportConfig associated with at least one measurement identifier (measId) included in a measurement ID list (measIdList) within variable measurement configuration (VarMeasConfig) contains a reference signal (RS) type (rsType) set to SSB and SSB configuration mobility (ssb-ConfigMobility) is configured in the measObject indicated by the serving cell MO (e.g., servingCellMO), the UE shall derive serving cell measurement results based on the SSB. If the report configuration (reportConfig) associated with at least one measId included in the measIdList within VarMeasConfig contains a report quantity RS indexes (reportQuantityRS-Indexes) and a maximum number of RS indexes to report (maxNrofRS-IndexesToReport) and contains an rsType set to SSB, the UE shall derive L3 filtered RSRP and RSRQ per beam for the serving cell based on SSB. Except as otherwise described herein, the configuration elements/parameters may be similar to those described 3GPP TS 38.331 v 18.5.1(2025 Mar. 21).

In some embodiments, the network may configure UE 104 with RRC signaling to deactivate the serving cell MO (e.g., servingCellMO) when OD-SSB transmission is deactivated. This allows UE 104 to stop measurements on the SCell without requiring additional specification changes. In other embodiments, the network may configure UE 104 to start L3 measurements toward the activated OD-SSB based on the serving cell MO (e.g., servingCellMO) after receiving the activation MAC-CE. The network may also configure UE 104 to stop L3 measurements when OD-SSB transmission is deactivated, either explicitly via MAC-CE or implicitly based on predefined conditions. This dynamic signaling mechanism enables efficient measurement operations for UE 104 in scenarios involving OD-SSB transmission.

In some embodiments, a second case, referred to as Case 2, may involve the transmission of AO-SSBs on both the PCell and the SCell, with OD-SSBs being transmitted on the SCell as needed. In this configuration, AO-SSBs on the PCell provide a consistent synchronization reference for UE 104, while AO-SSBs on the SCell may enable continuous monitoring of the secondary connection. OD-SSBs on the SCell may be triggered by specific events or conditions, such as SCell activation or inter-frequency mobility scenarios, to support measurement operations. The coexistence of AO-SSBs on both the PCell and SCell, along with the flexible activation of OD-SSBs on the SCell, provides a robust framework for managing synchronization and measurement operations. For instance, BS 108 may configure the periodicity of AO-SSB transmissions on the PCell and SCell and activate OD-SSBs on the SCell as needed, enabling the network 102 to adapt to varying traffic and mobility conditions while maintaining efficient synchronization and measurement performance.

In some embodiments, L3 measurement in Case 2 may involve scenarios where both AO-SSB and OD-SSB are transmitted on the SCell. This configuration may be divided into two sub-cases: one where AO-SSB and OD-SSB operate on the same frequency and another where AO-SSB and OD-SSB operate on different frequencies. When AO-SSB and OD-SSB share the same frequency, the key challenge is determining whether UE 104 should perform measurements on AO-SSB, OD-SSB, or both. For example, in scenarios where AO-SSB and OD-SSB are transmitted concurrently on the same frequency, UE 104 may need to prioritize one or both SSBs for L3 measurements depending on network conditions or signaling instructions.

Before the completion of SCell activation, L3 measurement may be performed on the deactivated SCell. In this case, a parameter such as the SCell measurement cycle (measCycleSCell) may be configured for the deactivated SCell, specifying the periodicity of measurements. For example, the network may configure measCycleSCell with values corresponding to predefined sub-frame intervals, such as sf 160 (corresponding to 160 sub-frames) or sf 256 (corresponding to 256 sub-frames). This parameter allows UE 104 to continue performing measurements on the deactivated SCell for mobility management, handover preparation, or quality monitoring. The absence of explicit procedural text for L3 measurement on deactivated SCells in legacy solutions may lead to reliance on existing mechanisms, such as measCycleSCell, without introducing specification changes.

After the completion of SCell activation, L3 measurement may focus on adapting the transmission parameters of OD-SSB. For example, MAC-CE may be used to update the periodicity of OD-SSB transmissions on the SCell while maintaining its activation state. In this scenario, the solution for SSB adaptation may be reused, including the configuration of multiple SSB measurement timing configuration (SMTC) mappings between OD-SSB and SMTC configurations. Upon receiving an OD-SSB MAC-CE, UE 104 may select an appropriate SMTC configuration for L3 measurements on the serving cell. This approach may allow continuity in measurement operations without impacting neighbor cell L3 measurements, which remain based on legacy SMTC configurations.

In some embodiments, when AO-SSB and OD-SSB may share the same frequency before the completion of SCell activation, the network may configure L3 measurement on the deactivated SCell using existing mechanisms, such as measCycleSCell, without introducing new specification changes. After SCell activation, the network may configure UE 104 to adapt OD-SSB transmission parameters using MAC-CE. For example, the network may configure multiple SMTC mappings to facilitate L3 measurements based on OD-SSB and its transmission periodicity. This dynamic adjustment enables efficient synchronization and measurement operations for UE 104 across serving and neighbor cells.

In some embodiments, when AO-SSB and OD-SSB are configured on different frequencies, a new serving cell MO (e.g., servingCellMO) may be introduced in ServingCellConfig to indicate the MO associated with OD-SSB. This configuration allows the network to manage measurements on OD-SSB independently from AO-SSB. For example, the serving cell MO (e.g., servingCellMO) for OD-SSB may specify measurement parameters such as frequency, measurement bandwidth, and reporting thresholds, enabling UE 104 to perform L3 measurements on OD-SSB when activated. In some instances, it may also be considered whether multiple OD-SSBs with different frequencies can be configured for a single SCell, although this aspect may require further study and specification updates.

In some embodiments, it is assumed that introducing a new serving cell MO (e.g., servingCellMO) in ServingCellConfig for OD-SSB when AO-SSB and OD-SSB have different frequencies is the preferred approach, as alternative methods, such as adding the OD-SSB frequency to the serving cell MO (e.g., servingCellMO) identified by the AO-SSB frequency, may introduce significant specification impacts. For example, associating OD-SSB frequency directly with the AO-SSB serving cell MO (e.g., servingCellMO) could complicate the configuration process and increase signaling overhead. This approach allows the network to maintain a clear distinction between MOs associated with AO-SSB and OD-SSB, simplifying measurement and reporting operations for UE 104.

In some embodiments, when drafting configuration rules, it may be assumed that only one OD-SSB with a frequency different from AO-SSB can be configured for a given SCell. This assumption streamlines configuration and measurement processes, reducing potential conflicts or ambiguities in multi-frequency scenarios. However, this assumption may be revisited in the future if further discussions or studies suggest the need to support multiple OD-SSBs with different frequencies for a single SCell.

In some embodiments, when UE 104 applies the new serving cell MO (e.g., servingCellMO) for L3 measurements, it may do so only when OD-SSB is activated. For example, upon activation of OD-SSB, UE 104 may use the new serving cell MO (e.g., servingCellMO) to perform L3 measurements specific to OD-SSB. When OD-SSB is deactivated, UE 104 may revert to using the legacy serving cell MO (e.g., servingCellMO) for L3 measurements. This approach may allow the appropriate serving cell MO (e.g., servingCellMO) to be applied based on the activation state of OD-SSB, enabling accurate and efficient measurement operations across different frequency configurations.

In some embodiments, measurement reporting triggered by OD-SSB MAC-CE may be considered to reduce the transition time from an unknown SCell to a known SCell. For example, triggering fast measurement reporting immediately upon OD-SSB activation may allow UE 104 to quickly evaluate the signal quality of the SCell and facilitate mobility management or secondary cell activation. However, legacy solutions already provide mechanisms to address this issue. For instance, measurement reporting triggered by SCell activation/deactivation MAC-CE, introduced in earlier releases, enables UE 104 to perform timely reporting during SCell activation, achieving the same intended benefit without additional complexity.

In some embodiments, OD-SSB MAC-CE is expected to be sent earlier than SCell activation MAC-CE. This sequence may enable faster measurement reporting. In some embodiments, the network may avoid pursuing measurement reporting triggered by OD-SSB MAC-CE. For example, retaining the current approach of using SCell activation MAC-CE for measurement reporting may allow compatibility with existing systems and may avoid conflicts or disruptions in network operations.

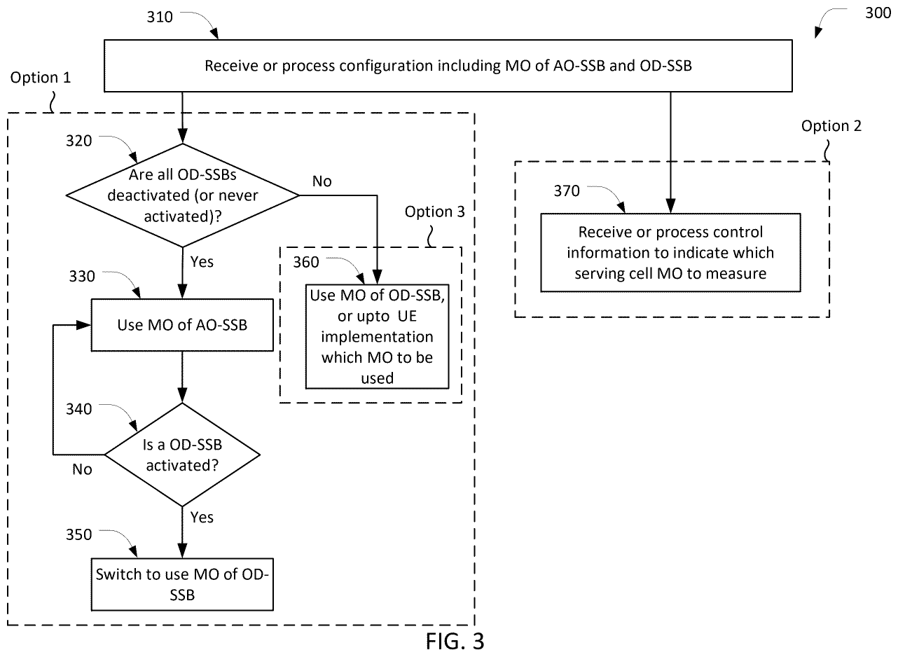

FIG. 3 illustrates an operation flow/algorithmic structure 300 in accordance with some embodiments. The operation flow/algorithmic structure 300 may be performed or implemented by a UE such as, for example, the UE 104 or UE 900; or components thereof, for example, baseband processor circuitry 904A.

In some embodiments, the operation flow/algorithmic structure 300 may provide three high-level options for managing UE 104's measurement operations when AO-SSB and OD-SSB are configured. The first option may allow UE 104 to dynamically adapt its measurement behavior based on the activation state of OD-SSB. If OD-SSBs are deactivated or have never been activated, UE 104 performs measurements using the MO associated with AO-SSB. If OD-SSB is activated, UE 104 switches to using the MO associated with OD-SSB. The second option may provide explicit network control, where BS 108 transmits a control element to indicate which serving cell MO UE 104 should measure. The third option may enable the UE 104 to autonomously decide which MO to prioritize based on implementation-specific criteria, such as network conditions or predefined parameters.

The operation flow/algorithmic structure 300 may include, at 310, process configuration, including MO of AO-SSB and OD-SSB. These configurations may define parameters such as frequency, bandwidth, and reporting thresholds. The configurations may also specify event-triggered or periodic measurement modes. This step ensures that UE 104 has the necessary information to perform measurements on AO-SSB or OD-SSB as required by the network. After completing the operation at 310, the process may transition to 320 to determine the activation state of OD-SSBs. Additionally, or alternatively, under Option 2, the process may transition directly to 370, where BS 108 explicitly indicates the serving cell MO to measure.

The operation flow/algorithmic structure 300 may include, at 320, determining whether all OD-SSBs are deactivated or have never been activated. For instance, OD-SSBs may be deactivated explicitly via MAC-CE or implicitly after a predefined number of transmissions. If the determination at 320 is positive, UE 104 identifies that OD-SSBs are not active and transitions to 330 to use the MO associated with AO-SSB. If the determination at 320 is negative, the process may transition to 360, where UE 104 autonomously decides which MO to prioritize based on implementation-specific criteria.

The operation flow/algorithmic structure 330 may include, at 330, using the MO associated with AO-SSB. In this operation, UE 104 performs measurements based on AO-SSB to continuously monitor the serving cell and neighbor cells. The MO associated with AO-SSB may define the measurement parameters required for mobility management and network monitoring. This ensures that UE 104 maintains a consistent synchronization reference when OD-SSBs are deactivated. After completing the operation at 330, the process transitions to 340 to determine whether OD-SSB is activated.

The operation flow/algorithmic structure 300 may include, at 340, determining whether an OD-SSB is activated. For example, BS 108 may transmit a MAC-CE to indicate the activation of OD-SSB for specific serving cells. If OD-SSB is activated, UE 104 identifies the activation and transitions to 350 to switch its measurement focus to OD-SSB. If the determination at 340 is negative, the process loops back to 330, allowing UE 104 to continue using the MO associated with AO-SSB.

The operation flow/algorithmic structure 300 may include, at 350, switching to use the MO associated with OD-SSB. In this operation, UE 104 performs event-triggered measurements based on OD-SSB, such as during secondary cell activation or inter-frequency handover. The MO associated with OD-SSB specifies the parameters for these measurements, enabling UE 104 to evaluate the signal quality of the SCell or prepare for mobility events. After completing the operation at 350, the process may loop back to 320 to evaluate the activation state of OD-SSBs in subsequent cycles.

The operation flow/algorithmic structure 300 may include, at 360, using MO of OD-SSB or up to UE implementation to decide which MO to use. The operation flow/algorithmic structure 300 may allow UE 104 to autonomously decide which MO to prioritize based on implementation-specific criteria. This operation is associated with Option 3, where UE 104 independently evaluates factors to determine the most suitable MO for measurements. For example, UE 104 may consider the frequency configuration of AO-SSB and OD-SSB, the activation state of OD-SSB, or conditions predefined by BS 108 to decide whether to use MO1 or MO2 for measurements. This autonomous decision-making process enables UE 104 to optimize its measurement behavior without requiring explicit signaling from the network. After completing the operation at 360, the process may loop back to 320 to re-evaluate the activation state of OD-SSBs if needed.

The operation flow/algorithmic structure 300 may include, at 370, processing a control element that indicates which serving cell MO to measure. This operation is associated with Option 2, where BS 108 provides explicit instructions to UE 104 regarding the serving cell MO to be prioritized. For example, BS 108 may transmit a MAC-CE with a bitmap field identifying the serving cell for measurements. UE 104 may process the control element, identify the MO associated with the specified serving cell, and perform measurements accordingly. This operation allows BS 108 to dynamically configure UE 104's measurement focus, ensuring proper prioritization of AO-SSB or OD-SSB-associated MOs. After completing the operation at 370, the process may transition back to 310 to update or refine the configuration of MOs for subsequent measurement cycles.

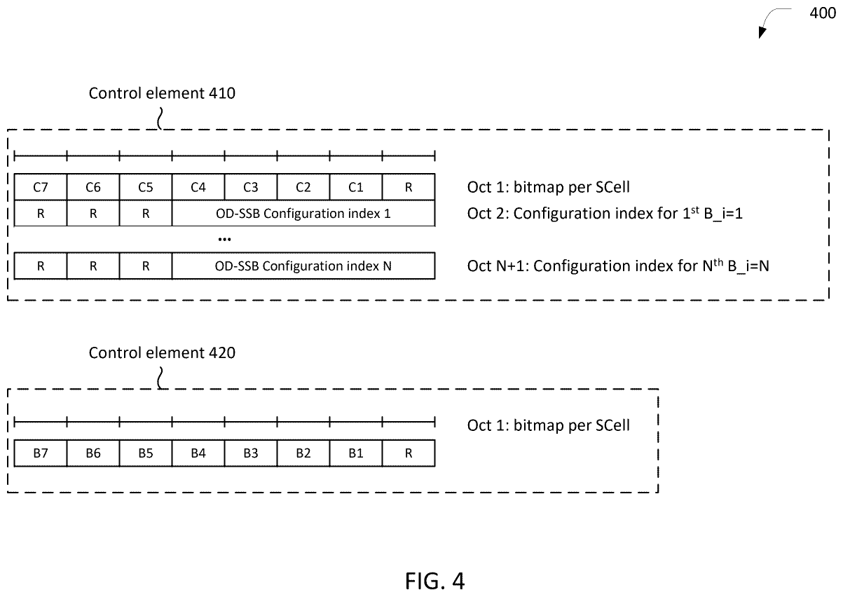

FIG. 4 illustrates control elements 400 in accordance with some embodiments. Control elements 400 includes control element 410 and control element 420. The control element 410 may be used to activate or deactivate OD-SSB or select which serving cell to be measured. The control element 420 may be used to select which serving cell to be measured.

In some embodiments, the BS 108 may configure the UE 104 with a control element 410. The control element 410 may support both explicit and implicit deactivation of OD-SSBs. In some instances, the control element 410 may be a MAC CE. The control element 410 may include multiple octets, with each row in FIG. 3 representing an octet. The first octet may include a bitmap field where each bit (C1, C2, C3, etc.) corresponds to an SCell, and a reserved bit “R” is allocated. The second octet may correspond to the first nonzero bit in the bitmap and contains three reserved bits, “R,” and five bits that specify the OD-SSB configuration index. This structure repeats for each nonzero bit in the bitmap, allowing the network 102 to dynamically scale the management of multiple SCells.

The control element 410 may explicitly activate or deactivate OD-SSBs for each SCell. A bit value of “1” in the bitmap may signal activation, while a bit value of “0” may signal deactivation. In some instances, the MAC-CE may support two formats: one format may accommodate up to seven SCells, while the other may accommodate up to 31 SCells. When OD-SSB is activated for an SCell, UE 104 may apply the corresponding OD-SSB configuration index, which enables it to perform L3 measurements based on the activated configuration.

In some embodiments, the control element 410 may implement implicit deactivation by checking whether a parameter to define a number of bursts for an OD-SSB, “od-ssb-nrofBurst,” exists in the OD-SSB configuration indicated by the configuration index. When “od-ssb-nrofBurst” is absent, UE 104 may interpret this as implicit deactivation and stops OD-SSB transmission. For example, when the configuration index points to an OD-SSB configuration where “od-ssb-nrofBurst” is set to zero, UE 104 may halt transmission without requiring explicit signaling through RRC messages. This mechanism may simplify the deactivation process and may reduce signaling overhead.

The network 102 may perform early deactivation of OD-SSBs via the control element 410 before completing the predefined number of OD-SSB transmissions (“N”). For instance, the network 102 sends a MAC-CE with a configuration index that points to an OD-SSB configuration where “od-ssb-nrofBurst” is set to zero, enabling UE 104 to immediately stop OD-SSB transmission. Alternatively, the network 102 may first send a MAC-CE to initiate explicit deactivation by setting the bitmap bit to “1” and indicating the absence of “od-ssb-nrofBurst” in the configuration index. Following this, the network 102 may send another MAC-CE to explicitly deactivate OD-SSB by setting the bitmap bit to “0.”

UE 104 may interpret the bitmap field in the control element 410 based on whether the SCell operates under explicit or implicit deactivation. When the bitmap bit is set to “1,” UE 104 activates the corresponding SCell and applies the associated OD-SSB configuration. When the bitmap bit is set to “0 ,” UE 104 determines the deactivation type based on the configuration status of “od-ssb-nrofBurst.” If “od-ssb-nrofBurst” was not configured prior to receiving the MAC-CE, UE 104 treats the deactivation as explicit and stops OD-SSB transmission. If “od-ssb-nrofBurst” was configured, UE 104 treats the deactivation as implicit and continues counting OD-SSB transmissions based on the previously configured parameters.

The control element 410 may provide the network 102 with a flexible tool to manage OD-SSBs across multiple SCells. By leveraging the bitmap field and configuration index, the network 102 may dynamically activate or deactivate OD-SSBs, enabling UE 104 to perform synchronization and measurement operations. This design accommodates scalability and adapts to varying network conditions, traffic patterns, and mobility requirements.

In some embodiments, the control element 420, referred to as a dedicated MAC-CE, may facilitate the selection of MOs for serving cells. The control element 420 may include a bitmap with bits B1 to B7, each corresponding to a specific SCell and a reserved bit. This design may enable the network 102 to dynamically instruct UE 104 on which serving cell MO to prioritize for L3 measurements. The simplicity and compactness of control element 420 may make it an efficient signaling mechanism for managing measurement operations across multiple SCells.

The bits in the bitmap (B1 to B7) indicate the serving cell MO to be used for measurement. For example, if a bit Bi is set to “1,” UE 104 may use the MO associated with OD-SSB for serving cell measurement in the SCell identified by SCellIndex i. Conversely, if a bit Bi is set to “0 ,” UE 104 may use the MO associated with AO-SSB for measurement in the corresponding SCell. The reserved bit “R” is set to 0 and serves as a placeholder to maintain the byte alignment of the control element. This design may provide a clear signaling for measurement object selection while reducing signaling overhead.

The control element 420 may provide flexibility for the network 102 in managing measurement operations. Even if OD-SSB is activated, the network 102 may prefer UE 104 to continue L3 measurements based on AO-SSB under specific conditions. For example, in scenarios where AO-SSB provides a more reliable synchronization reference or is required for ongoing mobility management operations, the network 102 can use control element 420 to explicitly signal UE 104 to prioritize AO-SSB-associated MO for measurements. This flexibility allows the network to dynamically adapt measurement priorities based on real-time operational needs.

In some embodiments, the network 102 may configure the control element 420 with a new logical channel identifier (LCID) or enhanced LCID (eLCID) to distinguish it from other MAC-CEs. This identifier ensures that UE 104 interprets control element 420 as a directive for measurement object selection rather than other signaling purposes. When UE 104 processes control element 420, it evaluates the bitmap field to determine the measurement objects for the specified SCells and performs measurements accordingly.

The control element 420 provides a streamlined mechanism for managing measurement object selection in scenarios involving AO-SSB and OD-SSB configurations. By leveraging the bitmap field, the network 102 may dynamically guide the UE 104 in prioritizing serving cell measurements, allowing synchronization and mobility management. This design may support adaptability across varying network conditions, traffic patterns, and operational requirements.

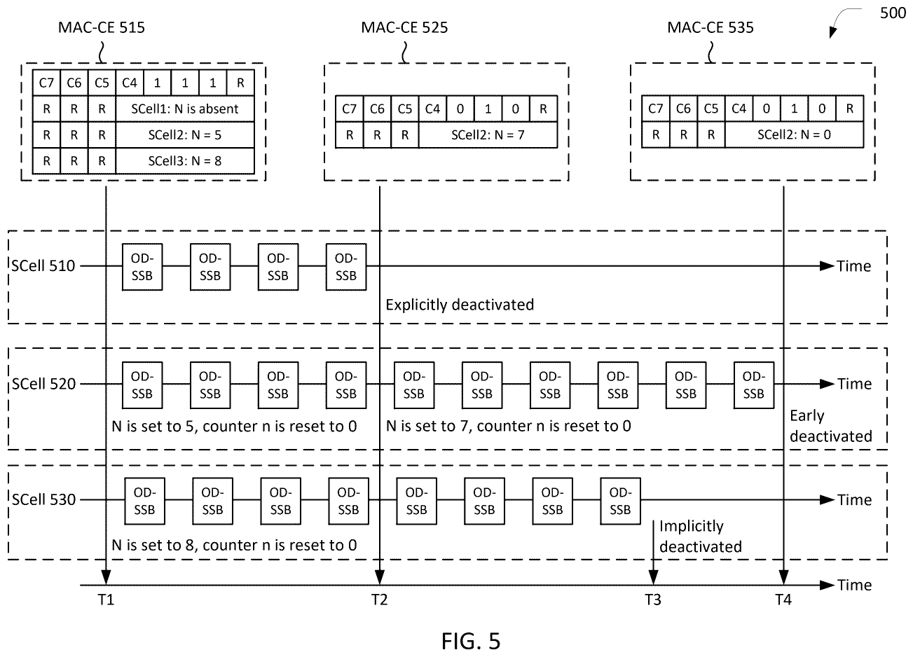

FIG. 5 illustrates a signaling diagram 500 in accordance with some embodiments. The signaling diagram 500 shows the transmission of OD-SSB on SCells 510, 520, and 530. The operations depicted in FIG. 5 describe how the network 102 uses MAC CEs to dynamically manage the activation, configuration, and deactivation of OD-SSB on various SCells.

At T1, network 102 may generate or transmit MAC CE 515 to UE 104. MAC CE 515 is an example of MAC CE 410 of FIG. 4. The first octet of MAC CE 515 includes a bitmap field with values [C7 C6 C5 C4 1 1 1 R], where bits C4 to C7 are set to “0” or are not used, while bits C1, C2, and C3 are set to “1.” The bitmap indicates that OD-SSB is activated on the SCells corresponding to C1 (SCell 510), C2 (SCell 520), and C3 (SCell 530). For SCell 510 (associated with C1), the next octet in MAC CE 515 specifies that the parameter “N” (used for implicit deactivation) is absent. When N is absent, UE 104 may interpret this as an indication to continue OD-SSB transmission indefinitely until explicitly deactivated via a subsequent MAC CE or RRC signaling. This behavior may allow OD-SSB transmission on SCell 510 to remain active without a predefined limit. For SCell 520 (associated with C2), the third octet specifies that N=5. When N is configured, UE 104 may initiate a counter for OD-SSB transmissions, starting at zero, and increments it with each OD-SSB transmission. After five OD-SSB transmissions, the counter reaches the value of N, and UE 104 may implicitly deactivate OD-SSB on SCell 520. For SCell 530 (associated with C3), the fourth octet specifies that N=8. Similar to the configuration for SCell 520, UE 104 resets the associated counter for SCell 530 and starts counting from zero. After eight OD-SSB transmissions on SCell 530, the counter saturates, and OD-SSB transmission is implicitly deactivated on this SCell.

At T2, network 102 generates and transmits MAC CE 525 to UE 104. MAC CE 525 is an example of MAC CE 410 of FIG. 4. The first octet of MAC CE 525 includes a bitmap field where C1=0, C2=1, and C3=0, indicating that OD-SSB is activated on SCell 520 (C2), while deactivated on SCell 510 (C1) and SCell 530 (C3). The next octet specifies the OD-SSB configuration for SCell 520 (associated with the first bit set to “1” in the bitmap), changing the value of N to 7. Upon receiving this MAC CE, UE 104 processes the configuration and resets the counter associated with SCell 510, initiating a new counting process with N=7. This allows UE 104 to perform up to seven OD-SSB transmissions on SCell 510 before implicit deactivation occurs unless further reconfiguration is provided by network 102.

At T3, OD-SSB transmissions continue on SCell 530 (associated with C3), as configured at T1 with N=8. After eight OD-SSB transmissions, the counter associated with SCell 530 reaches the value of N, and UE 104 implicitly deactivates OD-SSB on SCell 530. This behavior is consistent with the implicit deactivation mechanism, where the counter dictates the maximum number of OD-SSB transmissions before termination.

At T4, network 102 generates and transmits MAC CE 535 to UE 104. MAC CE 535 is an example of MAC CE 410 of FIG. 4. The first octet of MAC CE 535 may include a bitmap field where C1=0, C2=1, and C3=0, indicating that OD-SSB is activated on SCell 520 (C2) and deactivated on SCells 510 (C1) and 530 (C3). The next octet may indicate the OD-SSB configuration for SCell 520 (associated with the first bit set to “1” in the bitmap), setting N=0. Upon receiving or processing MAC CE 535, UE 104 may interpret the configuration as an instruction to immediately deactivate OD-SSB on SCell 520. Setting N=0 may enable the network 102 to perform early deactivation of OD-SSB on SCell 520, terminating transmission without requiring UE 104 to wait for the counter to saturate.

The signaling operations depicted in FIG. 5 demonstrate the flexibility and precision of MAC CE-based OD-SSB management. By dynamically adjusting the activation, configuration, and deactivation of OD-SSB on various SCells, network 102 efficiently coordinates synchronization and measurement operations while adapting to varying network conditions and mobility requirements.

In some embodiments, network 102 may employ multiple methods for activating and deactivating OD-SSBs to enable synchronization and measurement operations across SCells. Activation of OD-SSBs may be initiated explicitly through signaling mechanisms, such as MAC-CEs or RRC signaling, where the network 102 may specify the SCells and associated configurations for OD-SSB transmission. For example, activation may involve setting specific bits in a bitmap field to indicate the SCells where OD-SSBs are enabled. Implicit activation may also occur under predefined conditions, such as secondary cell activation or mobility-related triggers, enabling OD-SSBs to support event-driven synchronization and measurement requirements.

In some embodiments, deactivation of OD-SSBs may be performed either explicitly or implicitly. Explicit deactivation may occur when the network transmits signaling instructions to UE 104, specifying the termination of OD-SSB transmissions on particular SCells. Implicit deactivation may rely on predefined parameters, such as the value of N, which may define the maximum number of OD-SSB transmissions allowed before automatic termination. When the counter associated with an OD-SSB configuration reaches the value of N, UE 104 may automatically stop OD-SSB transmission on the corresponding SCell. Additionally, early deactivation may be enabled by configuring N to zero, allowing the network to terminate OD-SSB transmission immediately without requiring the counter to saturate. These methods may provide the network with the flexibility to dynamically manage OD-SSB operations based on real-time traffic patterns, mobility requirements, and operational priorities.

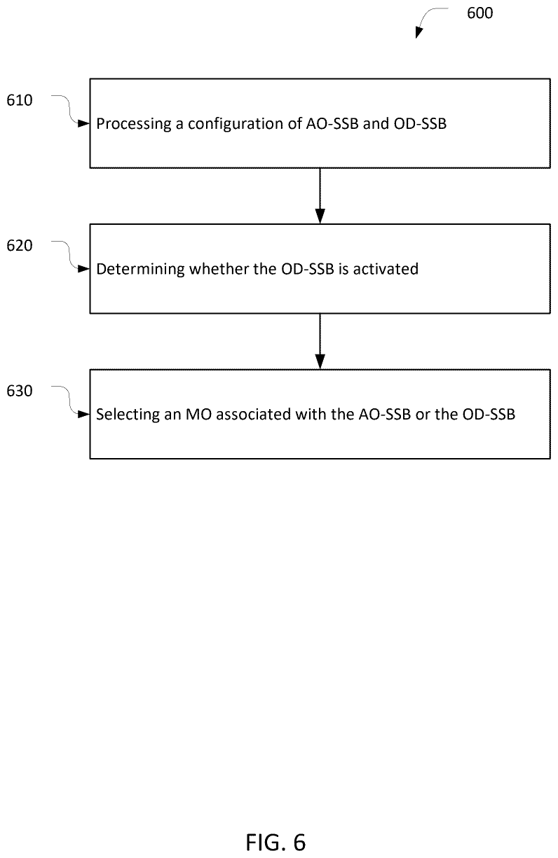

FIG. 6 illustrates an operation flow/algorithmic structure 600, also referred to as the process 600, in accordance with some embodiments. The operation flow/algorithmic structure 600 may be performed or implemented by a UE such as, for example, the UE 104 or UE 900; or components thereof, for example, baseband processor circuitry 904A.

The operation flow/algorithmic structure 600 may include, at 610, processing a configuration of AO-SSB and OD-SSB. The process 600 may cause the UE 104 to receive configurations of AO-SSB and OD-SSB from network 102 via signaling mechanisms such as RRC messages or MAC CEs. The configuration of AO-SSB may include parameters such as transmission periodicity, frequency allocation, and beamforming information, enabling UE 104 to perform periodic synchronization and monitoring operations. The configuration of OD-SSB may include parameters for event-triggered synchronization, such as activation conditions and implicit deactivation criteria. For example, OD-SSB may be activated during secondary cell activation or specific mobility scenarios. UE 104 processes these configurations to ensure it has the necessary information to perform L3 measurements based on AO-SSB and OD-SSB, as required by the network.

The operation flow/algorithmic structure 600 may include, at 620, determining whether the OD-SSB is activated. The process 600 may cause the UE 104 to evaluate or determine the activation state of OD-SSB based on signaling received from network 102. This evaluation may involve monitoring a counter associated with the number of OD-SSB transmissions for a specific SCell. If the counter reaches or exceeds a predefined threshold (N), UE 104 may determine that OD-SSB is implicitly deactivated. Alternatively, explicit deactivation may be signaled via MAC CE, allowing UE 104 to determine the deactivation state directly. This operation enables UE 104 to dynamically adjust its synchronization and measurement behavior based on OD-SSB activation.

In some embodiments, determining whether OD-SSB is activated may involve receiving a MAC CE from network 102. The MAC CE may include a bitmap field, where each bit corresponds to an SCell. A bit value of “1” may indicate OD-SSB activation, while a bit value of “0” may indicate deactivation. UE 104 processes the bitmap field to determine the activation state of OD-SSB for each configured SCell. For example, if OD-SSB is activated on a specific SCell, UE 104 may use the OD-SSB configuration for measurements. If OD-SSB is deactivated, UE 104 may rely on the AO-SSB configuration for synchronization and monitoring.

In some embodiments, determining whether OD-SSB is activated may involve detecting ambiguity in the activation state. For example, if multiple OD-SSBs are associated with different SCells, UE 104 may encounter uncertainty in identifying the appropriate MO for measurements. In such cases, UE 104 may resolve ambiguity by selecting the MO associated with AO-SSB, ensuring consistent synchronization and measurement operations. This approach provides a fallback mechanism for scenarios where OD-SSB configurations are unclear or conflicting.

The operation flow/algorithmic structure 600 may include, at 630, selecting an MO associated with the AO-SSB or the OD-SSB. The process 600 may cause the UE 104 to select the MO based on the activation state of OD-SSB determined at 620. For example, if OD-SSB is activated, UE 104 may select the MO associated with OD-SSB for synchronization and measurement operations. In some instances, if OD-SSB is deactivated, the UE 104 may select the MO associated with AO-SSB for periodic synchronization and monitoring. This selection mechanism may enable the UE 104 to prioritize synchronization and measurement tasks based on real-time network conditions.

In some embodiments, the process 600 may cause the UE 104 to perform L3 measurements (or other measurements, e.g., layer 1 (L1) or layer 2 (L2) measurements) based on the selected MO. These measurements may include evaluating RSRP, RSRQ, or SINR. For example, UE 104 may perform L3 measurements (or other measurements, e.g., layer 1 (L1) or layer 2 (L2) measurements) on OD-SSB during secondary cell activation to assess signal quality and mobility readiness. Similarly, UE 104 may perform L3 measurements (or other measurements, e.g., layer 1 (L1) or layer 2 (L2) measurements) on AO-SSB to continuously monitor the serving cell and neighbor cells for mobility management and network optimization.

In some embodiments, selecting the MO may include processing a MAC CE that explicitly identifies the MO to measure. For example, network 102 may transmit a MAC CE with a bitmap field indicating the serving cell MO to prioritize or select. UE 104 may process the bitmap field and select the corresponding MO for synchronization and measurement operations. This explicit signaling mechanism may provide the network 102 with control over UE 104's measurement, allowing for prioritization of AO-SSB or OD-SSB-associated MOs.

In some embodiments, selecting the MO may include generating an indication of a preferred MO for transmission to network 102. For example, if OD-SSB is activated, UE 104 may transmit a preference for OD-SSB-associated MO to network 102, allowing the network to optimize synchronization and measurement configurations based on UE 104's real-time preferences. This operation enhances coordination between UE 104 and network 102, ensuring efficient synchronization and measurement operations across varying network conditions.

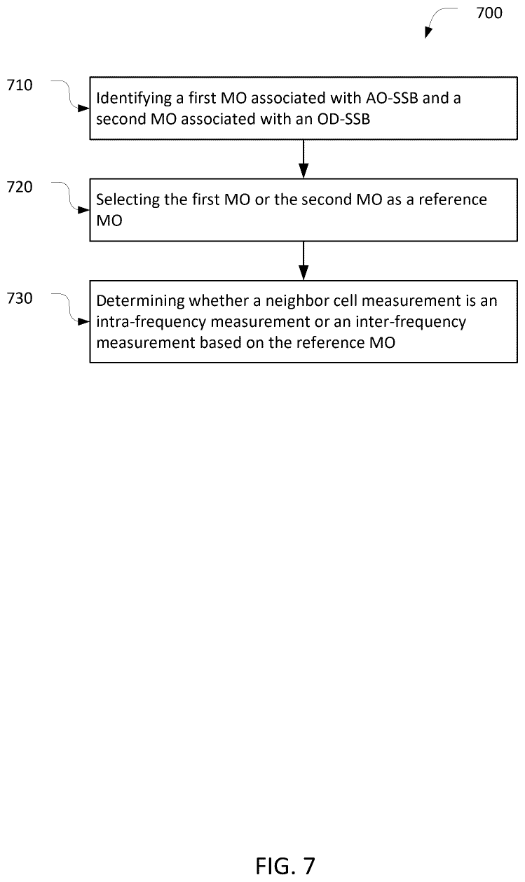

FIG. 7 illustrates an operation flow/algorithmic structure 700, also referred to as the process 700, in accordance with some embodiments. The operation flow/algorithmic structure 700 may be performed or implemented by a UE such as, for example, the UE 104 or UE 900; or components thereof, for example, baseband processor circuitry 904A.

The operation flow/algorithmic structure 700 may include, at 710, identifying a first MO associated with AO-SSB and a second MO associated with an OD-SSB. The process 700 may cause the UE 104 to receive configurations for AO-SSB and OD-SSB from network 102, specifying their associated MOs. The first MO may define parameters for synchronization and measurements based on AO-SSB, such as transmission periodicity, frequency allocation, and reporting thresholds. The second MO may define parameters for OD-SSB, including conditions for activation, implicit deactivation criteria, and event-driven measurement configurations. These MOs allow UE 104 to perform measurements tailored to the behavior and operational characteristics of AO-SSB and OD-SSB. By identifying the first and second MOs, UE 104 establishes the necessary framework for selecting the appropriate reference MO for neighbor cell measurements.

The operation flow/algorithmic structure 700 may include, at 720, selecting the first MO or the second MO as a reference MO. The process 700 may cause the UE 104 to select the reference MO based on the activation state of OD-SSB. For example, if OD-SSB is activated, UE 104 may select the second MO associated with OD-SSB as the reference MO. Conversely, if OD-SSB is deactivated, The process 700 may cause the UE 104 to select the first MO associated with AO-SSB as the reference MO. This selection mechanism ensures that UE 104 uses the most relevant MO for measuring neighbor cells based on real-time network conditions. In some embodiments, network 102 may transmit an information element (IE) to UE 104 to guide the selection of the reference MO. The IE may include frequency-specific information, enabling UE 104 to dynamically switch between AO-SSB and OD-SSB frequencies as the reference for neighbor cell measurements. For example, the IE may indicate whether the frequency of AO-SSB or OD-SSB should be used as the reference, providing explicit signaling for measurement operations.

The operation flow/algorithmic structure 700 may include, at 730, determining whether a neighbor cell measurement is an intra-frequency measurement or an inter-frequency measurement based on the reference MO. The process 700 may cause the UE 104 to compare the frequency of the reference MO with the frequency of the neighbor cell measurement to classify the measurement type. If the frequencies match, UE 104 determines the measurement as intra-frequency. If the frequencies differ, UE 104 determines the measurement as inter-frequency. This classification mechanism allows UE 104 to accurately characterize neighbor cell measurements, supporting mobility management, handover preparation, and interference mitigation. For example, when OD-SSB is activated, UE 104 may use the frequency of OD-SSB as the reference to determine the measurement type for neighbor cells. Similarly, when OD-SSB is deactivated, UE 104 may use the frequency of AO-SSB as the reference for measurement classification.

In some embodiments, selecting the reference MO may involve receiving an IE from network 102. The IE may explicitly indicate whether UE 104 should use the MO associated with AO-SSB or the MO associated with OD-SSB as the reference. For example, the IE may include frequency information that specifies the conditions under which AO-SSB or OD-SSB should be prioritized for neighbor cell measurements. By processing the IE, UE 104 ensures that the selection of the reference MO aligns with network preferences and operational requirements.

In some embodiments, selecting the reference MO may include resolving ambiguity in measurement configurations. For example, when multiple OD-SSBs are associated with different SCells, UE 104 may encounter uncertainty in identifying the appropriate reference MO for neighbor cell measurements. In such cases, network 102 may configure UE 104 to use the MO associated with AO-SSB as the default reference MO, ensuring consistent synchronization and measurement operations. This approach provides a fallback mechanism for scenarios where OD-SSB configurations are unclear or conflicting.

In some embodiments, determining whether a neighbor cell measurement is intra-frequency or inter-frequency may involve comparing the frequency of the reference MO with the frequency of the neighbor cell measurement. For example, UE 104 may use the frequency of OD-SSB as the reference when OD-SSB is activated and the frequency of AO-SSB when OD-SSB is deactivated. By dynamically adjusting the reference MO based on activation states and network instructions, UE 104 may classify the neighbor cell measurements.

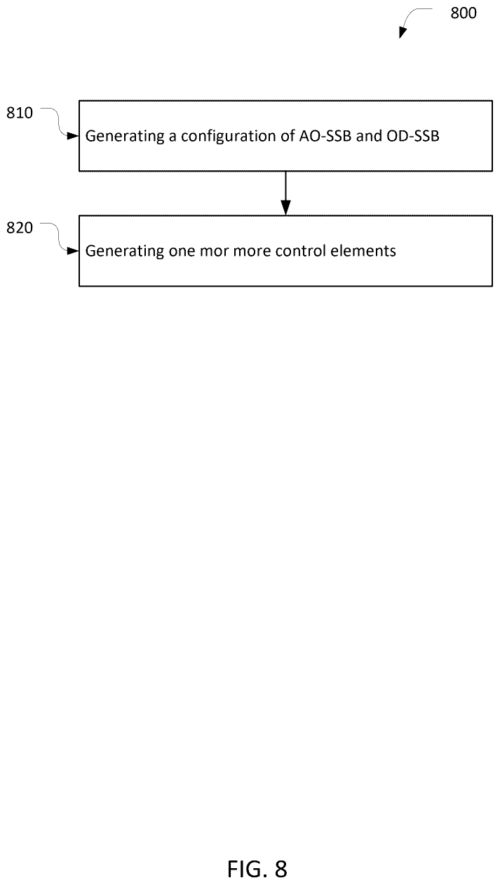

FIG. 8 illustrates an operational flow/algorithmic structure 800, also referred to as the process 800, in accordance with some embodiments. The operation flow/algorithmic structure 800 may be performed or implemented by a base station such as, for example, the base station 108 or the base station 1000; or components thereof, for example, baseband processor circuitry 1004A.

The operation flow/algorithmic structure 800 may include, at 810, generating a configuration of AO-SSB and OD-SSB. The process 800 may cause the network 102 to configure AO-SSB and OD-SSB for a serving cell to enable synchronization and measurement operations for UE 104. The configuration of AO-SSB may include parameters such as transmission periodicity, frequency allocation, and beamforming information, providing UE 104 with a consistent synchronization reference for periodic measurements. The configuration of OD-SSB may include parameters for event-driven synchronization, such as activation conditions, implicit deactivation criteria, and the number of transmission bursts before deactivation. For example, network 102 may configure OD-SSB to support secondary cell activation or specific mobility scenarios. These configurations may be transmitted to UE 104 via signaling mechanisms such as RRC messages or MAC CEs.

In some embodiments, the process 800 may cause the network 102 to dynamically adjust the configurations of AO-SSB and OD-SSB to adapt to varying traffic patterns, mobility requirements, or operational priorities. For example, network 102 may modify OD-SSB parameters to increase or decrease the number of transmission bursts or adjust activation conditions based on real-time network conditions. These adjustments ensure that UE 104 receives optimized synchronization and measurement configurations tailored to the specific needs of serving and neighbor cells.

In some embodiments, the configuration of OD-SSB may include an indication of activation or deactivation state. For instance, network 102 may specify whether OD-SSB is enabled or disabled for a particular serving cell, allowing UE 104 to dynamically adapt its measurement operations based on the activation state. This ensures that UE 104 prioritizes measurements on active OD-SSBs while relying on AO-SSB configurations when OD-SSBs are deactivated.

The operation flow/algorithmic structure 800 may include, at 820, generating one or more control elements. The process 800 may cause the network 102 to generate medium access control (MAC) CEs to manage the activation, configuration, and deactivation of OD-SSBs for serving cells. The MAC CEs may include bitmap fields where each bit corresponds to a specific serving cell, indicating whether OD-SSB is activated or deactivated. For example, a bit value of “1” may signal activation, while a bit value of “0” may signal deactivation. These bitmap fields enable network 102 to dynamically control OD-SSB operations across multiple serving cells.

In some embodiments, the MAC CEs may also include configuration details for OD-SSBs, such as the number of transmission bursts (N) before implicit deactivation. Network 102 may specify N for each activated OD-SSB, allowing UE 104 to manage OD-SSB transmissions based on predefined limits. If N is set to zero, UE 104 interprets this as an instruction for immediate deactivation of OD-SSB. This mechanism provides network 102 with the flexibility to perform early deactivation or extend OD-SSB transmissions based on real-time operational needs.

In some embodiments, the MAC CEs may also include bitmap fields indicating which serving cell MO UE 104 should prioritize for measurements. For instance, network 102 may transmit a MAC CE with a bitmap field specifying the serving cell MO to measure. UE 104 processes the bitmap field and selects the corresponding MO for synchronization and measurement operations. This explicit signaling mechanism provides network 102 with control over UE 104's measurement focus, ensuring proper prioritization of AO-SSB or OD-SSB-associated MOs.

In some embodiments, the process 800 may cause the network 102 to generate an information element (IE) to guide UE 104 in selecting a reference MO for neighbor cell measurements. The IE may include frequency-specific information, enabling UE 104 to dynamically switch between AO-SSB and OD-SSB frequencies as the reference for intra-frequency or inter-frequency measurement classification. For example, the IE may indicate whether the frequency of AO-SSB or OD-SSB should be used as the reference, providing explicit signaling for measurement operations.

In some embodiments, the process 800 may cause the network 102 to generate an indication for transmission to UE 104 to select an MO associated with AO-SSB as the default reference MO. For example, in scenarios where OD-SSB configurations are unclear or conflicting, network 102 may instruct UE 104 to prioritize AO-SSB-associated MO for synchronization and measurement operations. This approach ensures consistent synchronization and measurement operations, providing a fallback mechanism for ambiguous configurations.

In some embodiments, the process 800 may cause the network 102 to generate an indication for transmission to UE 104 to enable autonomous switching between MOs associated with AO-SSB and OD-SSB. For instance, network 102 may configure UE 104 with predefined criteria for selecting MOs based on activation states, frequency configurations, or mobility requirements. This autonomous switching mechanism provides UE 104 with the flexibility to adapt its measurement operations without requiring explicit network instructions.

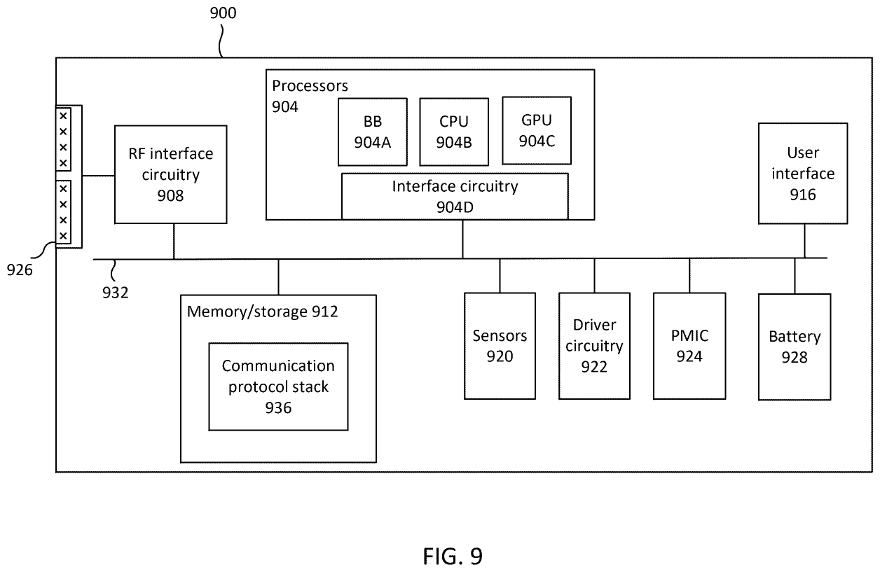

FIG. 9 illustrates a UE 900 in accordance with some embodiments. The UE 900 may be similar to and substantially interchangeable with the UE 104.

The UE 900 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smartwatch), or Internet-of-things devices.

The UE 900 may include processors 904, RF interface circuitry 908, memory/storage 912, user interface 916, sensors 920, driver circuitry 922, power management integrated circuit (PMIC) 924, antenna 926, and battery 928. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangements of the components shown may occur in other implementations.

The components of the UE 900 may be coupled with various other components over one or more interconnects 932, which may represent any type of interface, input/output, bus (local, system, or expansion), transmission line, trace, or optical connection that allows various circuit components (on common or different chips or chipsets) to interact with one another.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage 912 to cause the UE 900 to perform operations as described herein. The processors 904 may also include interface circuitry 904D to communicatively couple the processor circuitry with one or more other components of the UE 900.

In some embodiments, the baseband processor circuitry 904A may access a communication protocol stack 936 in the memory/storage 912 to communicate over a 3GPP-compatible network. In general, the baseband processor circuitry 904A may access the communication protocol stack 936 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 908.

The baseband processor circuitry 904A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 912 may include one or more non-transitory, computer-readable media that includes instructions (for example, communication protocol stack 936) that may be executed by one or more of the processors 904 to cause the UE 900 to perform various operations described herein.

The memory/storage 912 includes any type of volatile or non-volatile memory that may be distributed throughout the UE 900. In some embodiments, some of the memory/storage 912 may be located on the processors 904 themselves (for example, memory/storage 912 may be part of a chipset that corresponds to the baseband processor circuitry 904A), while other memory/storage 912 is external to the processors 904 but accessible thereto via a memory interface. The memory/storage 912 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 908 may include transceiver circuitry and a radio frequency front module (RFEM) that allows the UE 900 to communicate with other devices over a radio access network. The RF interface circuitry 908 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 926 and proceed to filter and amplify (with a low-noise amplifier) the signal. The signal may be provided to a receiver of the transceiver that down-converts the RF signal into a baseband signal that is provided to the baseband processor of the processors 904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 926.

In various embodiments, the RF interface circuitry 908 may be configured to transmit/receive signals in a manner compatible with NR access technologies.

The antenna 926 may include antenna elements to convert electrical signals into radio waves to travel through the air and to convert received radio waves into electrical signals. The antenna elements may be arranged into one or more antenna panels. The antenna 926 may have antenna panels that are omnidirectional, directional, or a combination thereof to enable beamforming and multiple input, multiple output communications. The antenna 926 may include microstrip antennas, printed antennas fabricated on the surface of one or more printed circuit boards, patch antennas, or phased array antennas. The antenna 926 may have one or more panels designed for specific frequency bands including bands in FR1 or FR2.

The user interface 916 includes various input/output (I/O) devices designed to enable user interaction with the UE 900. The user interface 916 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 900.

The sensors 920 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 922 may include software and hardware elements that operate to control particular devices that are embedded in the UE 900, attached to the UE 900, or otherwise communicatively coupled with the UE 900. The driver circuitry 922 may include individual drivers allowing other components to interact with or control various input/output (I/O) devices that may be present within or connected to the UE 900. For example, driver circuitry 922 may include a display driver to control and allow access to a display device, a touchscreen driver to control and allow access to a touchscreen interface, sensor drivers to obtain sensor readings of sensors 920, and control and allow access to sensors 920, drivers to obtain actuator positions of electro-mechanic components or control and allow access to the electro-mechanic components, a camera driver to control and allow access to an embedded image capture device, audio drivers to control and allow access to one or more audio devices.

The PMIC 924 may manage power provided to various components of the UE 900. In particular, with respect to the processors 904, the PMIC 924 may control power-source selection, voltage scaling, battery charging, or DC-to-DC conversion.

A battery 928 may power the UE 900, although in some examples, the UE 900 may be mounted deployed in a fixed location and may have a power supply coupled to an electrical grid. The battery 928 may be a lithium-ion battery, a metal-air battery, such as a zinc-air battery, an aluminum-air battery, a lithium-air battery, and the like. In some implementations, such as in vehicle-based applications, the battery 928 may be a typical lead-acid automotive battery.

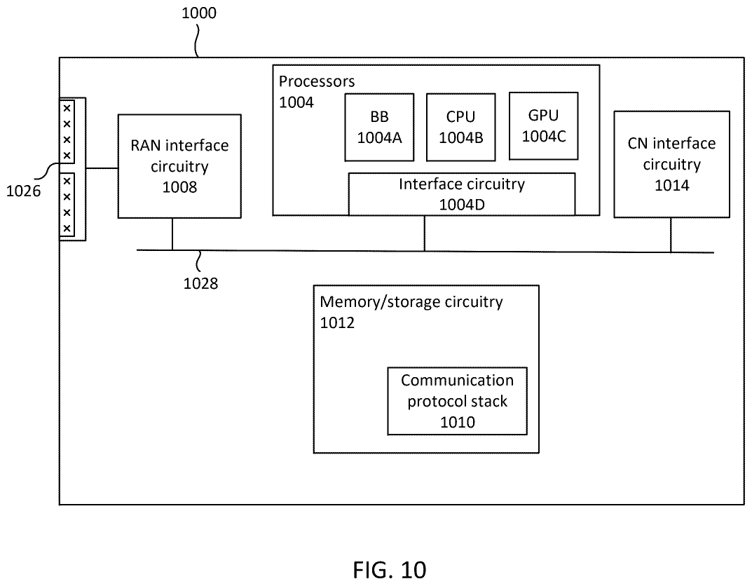

FIG. 10 illustrates a network device 1000 in accordance with some embodiments. The network device 1000 may be similar to and substantially interchangeable with base station 108.

The network device 1000 may include processors 1004, RF interface circuitry 1008 (if implemented as a base station), core network (CN) interface circuitry 1014, memory/storage circuitry 1012, and antenna structure 1026.

The components of the network device 1000 may be coupled with various other components over one or more interconnects 1028.

The processors 1004, RF interface circuitry 1008, memory/storage circuitry 1012 (including communication protocol stack 1010), antenna structure 1026, and interconnects 1028 may be similar to like-named elements shown and described with respect to FIG. 9.

The processors 1004 may include processor circuitry such as, for example, baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage circuitry 1012 to cause the UE 900 to perform operations as described herein. The processors 1004 may also include interface circuitry 1004D to communicatively couple the processor circuitry with one or more other components of the network device 1000.

The CN interface circuitry 1014 may provide connectivity to a core network, for example, a 5th Generation Core network (5GC) using a 5GC-compatible network interface protocol such as carrier Ethernet protocols or some other suitable protocol. Network connectivity may be provided to/from the network device 1000 via a fiber optic or wireless backhaul. The CN interface circuitry 1014 may include one or more dedicated processors or FPGAs to communicate using one or more of the aforementioned protocols. In some implementations, the CN interface circuitry 1014 may include multiple controllers to provide connectivity to other networks using the same or different protocols.

It is well understood that the use of personally identifiable information should follow privacy policies and practices generally recognized as meeting or exceeding industry or governmental requirements for maintaining users' privacy. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry described above in connection with one or more of the preceding figures may be configured to operate according to one or more of the examples set forth below. For another example, circuitry associated with a UE, base station, or network element described above in connection with one or more of the preceding figures may be configured to operate according to one or more of the examples set forth below in the example section.

### EXAMPLES

In the following sections, further exemplary embodiments are provided.

Example 1 includes the method of example 1 or some other examples herein, including: processing a configuration of an always-on (AO)-synchronization signal block (SSB) and a configuration of an on-demand (OD)-SSB associated with a serving cell; determining whether the OD-SSB is activated; and selecting a measurement object (MO) associated with the AO-SSB or the OD-SSB based on said determining whether the OD-SSB is activated.

Example 2 includes the method of example 1 or some other examples herein, wherein said determining whether the OD-SSB is activated includes: determining that the OD-SSB is activated and said selecting the MO includes selecting the MO associated with the OD-SSB.

Example 3 includes the method of example 1 or some other examples herein, wherein said determining whether the OD-SSB is activated includes: determining that the OD-SSB is not activated and said selecting the MO includes selecting the MO associated with the AO-SSB.

Example 4 includes the method of example 1 or some other examples herein, wherein said determining whether the OD-SSB is activated includes receiving a medium access control control element (MAC CE) from a network, the MAC CE includes an indication of activation or deactivation of the OD-SSB.

Example 5 includes the method of example 4 or some other examples herein, wherein the MAC CE includes a bitmap field that indicates whether the MO associated with the AO-SSB or OD-SSB is to be selected.

Example 6 includes the method of example 1 or some other examples herein, wherein said determining whether the OD-SSB is activated includes: determining that the OD-SSB is deactivated after a predefined number of transmissions.

Example 7 includes the method of example 1 or some other examples herein, wherein said determining whether the OD-SSB is activated includes processing a separate medium access control (MAC) control element (CE) from a network that explicitly identifies the MO to measure.

Example 8 includes the method of example 1 or some other examples herein, further including: detecting an ambiguity in determining the MO associated with the OD-SSB based on identifying one or more OD-SSBs associated with one or more secondary cells (SCells); and selecting the MO associated with the AO-SSB.

Example 9 includes the method of example 1 or some other examples herein, further including: performing layer 3 (L3) measurements based on the selected MO.

Example 10 includes the method of example 1 or some other examples herein, wherein said determining whether the OD-SSB is activated includes: monitoring a counter associated with a number of transmissions associated with the OD-SSB; and determining that the OD-SSB is deactivated when the counter reaches or exceeds a predefined threshold.

Example 11 includes the method of example 1 or some other examples herein, further including: generating an indication of a preferred MO for transmission to a network based on said determining whether the OD-SSB is activated.

Example 12 includes a method, including: identifying first and second measurement objects (MOs) of a serving cell, wherein the first MO is associated with an always-on (AO)-synchronization signal block (SSB) and the second MO is associated with an on-demand (OD)-SSB; and selecting the first MO or the second MO as a reference MO; and determining whether a neighbor cell measurement is an intra-frequency measurement or an inter-frequency measurement based on the reference MO.

Example 13 includes the method of example 12 or some other examples herein, further including: determining that the OD-SSB is activated; and selecting the second MO as the reference MO based on said determining that the OD-SSB is activated.

Example 14 includes the method of example 12 or some other examples herein,, further including: receiving an information element (IE); and selecting the first MO or the second MO as the reference MO based on the IE.

Example 15 includes the method of example 14 or some other examples herein, wherein the IE includes frequency information to indicate whether the first MO or the second MO is used as the reference MO.

Example 16 includes the method of example 12 or some other examples herein, wherein said selecting the reference MO includes: selecting the first MO associated with the AO-SSB as the reference MO when the OD-SSB is not activated.

Example 17 includes the method of example 12 or some other examples herein, wherein said determining whether the neighbor cell measurement is the intra-frequency measurement or the inter-frequency measurement includes: comparing a frequency of a neighbor cell measurement with a frequency of the first or second MOs.

Example 18 includes the method of example 18 or some other examples herein, including: generating a configuration of an always-on (AO)-synchronization signal block (SSB) and an on-demand (OD)-SSB associated with a serving cell to be transmitted to a user equipment (UE); and generating one or more medium access control (MAC) control elements (CEs) for transmission to the UE, the one or more MAC CEs is to: indicate an activation or deactivation state of the OD-SSB on a serving cells; and indicate the serving cell for measurement.

Example 19 includes the method of example 18 or some other examples herein, wherein the one or more MAC CEs include a bitmap field to indicate the activation or deactivation state of one or more OD-SSBs on a plurality of cells, the OD-SSB is in one or more OD-SSBs and the serving cell is in the plurality of serving cells.

Example 20 includes the method of example 18 or some other examples herein, wherein the one or more MAC CEs include a bitmap field to indicate the serving cell to be measured by the UE.

Example 21 includes the method of example 18 or some other examples herein, further including: configuring the OD-SSB to be deactivated after a predefined number of transmissions; and including an indication of the predefined number of transmissions in the one or more MAC CEs.

Example 22 includes the method of example 18 or some other examples herein, further including: generate an information element (IE) for transmission to the UE, wherein the IE indicate whether the UE is to use a measurement object (MO) associated with the AO-SSB or an MO associated with the OD-SSB as a reference MO for determining whether a neighbor cell measurement is an intra-frequency measurement or an inter-frequency measurement.

Example 23 includes the method of example 18 or some other examples herein, further including: generating an indication for transmission to the UE to select a measurement object (MO) associated with the AO-SSB as a default reference MO.

Example 24 includes the method of example 18 or some other examples herein, further including: generating an indication for transmission to the UE to enable the UE to autonomously switch between a measurement object (MO) associated with the AO-SSB and an MO associated with the OD-SSB as a reference MO based on UE implementation criteria.

Another example may include an apparatus comprising means to perform one or more elements of a method described in or related to any of examples 1-24, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-24, or any other method or process described herein.

Another example may include an apparatus comprising logic, modules, or circuitry to perform one or more elements of a method described in or related to any of examples 1-24, or any other method or process described herein.

Another example may include a method, technique, or process as described in or related to any of examples 1-24, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-24, or portions thereof.

Another example may include a signal as described in or related to any of examples 1-24, or portions or parts thereof.

Another example may include a datagram, information element, packet, frame, segment, PDU, or message as described in or related to any of examples 1-24, or portions or parts thereof, or otherwise described in the present disclosure.

Another example may include a signal encoded with data as described in or related to any of examples 1-24, or portions or parts thereof, or otherwise described in the present disclosure.

Another example may include a signal encoded with a datagram, IE, packet, frame, segment, PDU, or message as described in or related to any of examples 1-24, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-24, or portions thereof.

Another example may include a computer program comprising instructions, wherein execution of the program by a processing element is to cause the processing element to carry out the method, techniques, or process as described in or related to any of examples 1-24, or portions thereof.

Another example may include a signal in a wireless network as shown and described herein.

Another example may include a method of communicating in a wireless network, as shown and described herein.

Another example may include a system for providing wireless communication, as shown and described herein.

Another example may include a device for providing wireless communication, as shown and described herein.

Unless explicitly stated otherwise, any of the above-described examples may be combined with any other example (or combination of examples). The foregoing description of one or more implementations provides illustration and description but is not intended to be exhaustive or to limit the scope of embodiments to the precise form disclosed. Modifications and variations are possible in light of the above teachings or may be acquired from the practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing a configuration of an always-on (AO)-synchronization signal block (SSB) and a configuration of an on-demand (OD)-SSB associated with a serving cell;
determining whether the OD-SSB is activated; and
selecting a measurement object (MO) associated with the AO-SSB or the OD-SSB based on said determining whether the OD-SSB is activated; and
obtaining a measurement based on said selecting the MO.

2. The method of claim 1, wherein said determining whether the OD-SSB is activated includes:
determining that the OD-SSB is activated and said selecting the MO includes selecting the MO associated with the OD-SSB.

3. The method of claim 1, wherein said determining whether the OD-SSB is activated includes:
determining that the OD-SSB is not activated and said selecting the MO includes selecting the MO associated with the AO-SSB.

4. The method of claim 1, wherein said determining whether the OD-SSB is activated includes receiving a medium access control (MAC) control element (CE) from a network, wherein the MAC CE includes an indication of activation or deactivation of the OD-SSB.

5. The method of claim 4, wherein the MAC CE includes a bitmap field that indicates whether the MO associated with the AO-SSB or OD-SSB is to be selected.

6. The method of claim 1, wherein said determining whether the OD-SSB is activated includes:
determining that the OD-SSB is deactivated after a predefined number of transmissions.

7. The method of claim 1, wherein said determining whether the OD-SSB is activated includes processing a separate medium access control (MAC) control element (CE), received from a network, that explicitly identifies the MO to measure.

8. The method of claim 1, further comprising:
detecting an ambiguity in determining the MO associated with the OD-SSB based on identifying one or more OD-SSBs associated with one or more secondary cells (SCells); and
selecting the MO associated with the AO-SSB.

9. The method of claim 1, wherein said determining whether the OD-SSB is activated includes:
monitoring a counter associated with a number of transmissions associated with the OD-SSB; and
determining that the OD-SSB is deactivated when the counter reaches or exceeds a predefined threshold.

10. The method of claim 1, further comprising:
generating, for transmission to a network, an indication of a preferred MO based on said determining whether the OD-SSB is activated.

11. An apparatus comprising:
processor circuitry to:
identify first and second measurement objects (MOs) of a serving cell, wherein the first MO is associated with an always-on (AO)-synchronization signal block (SSB) and the second MO is associated with an on-demand (OD)-SSB;
select the first MO or the second MO as a reference MO;
determine whether a neighbor cell measurement is an intra-frequency measurement or an inter-frequency measurement based on the reference MO; and
perform the neighbor cell measurement based at least in part on the determination; and
interface circuitry coupled to the processor circuitry, the interface circuitry to receive configuration information to indicate the first and second MOs.

12. The apparatus of claim 11, wherein the processor circuitry is further to:
determine that the OD-SSB is activated; and
select the second MO as the reference MO based on said determining that the OD-SSB is activated.

13. The apparatus of claim 11, wherein the processor circuitry is further to:
receive an information element (IE) that includes frequency information to indicate whether the first MO or the second MO is used as the reference MO.

14. The apparatus of claim 11, wherein to select the reference MO includes to select the first MO associated with the AO-SSB as the reference MO when the OD-SSB is not activated.

15. A method comprising:
generating a configuration of an always-on (AO)-synchronization signal block (SSB) and an on-demand (OD)-SSB associated with a serving cell to be transmitted to a user equipment (UE); and
generating at least one medium access control (MAC) control element (CE) for transmission to the UE, wherein the at least one MAC CE is to:
indicate an activation or deactivation state of the OD-SSB on a serving cell; and
indicate the serving cell for measurement.

16. The method of claim 15, wherein the OD-SSB is a first OD-SSB, the serving cell is a first serving cell, and the at least one MAC CE includes a bitmap field to indicate the activation or deactivation state of a plurality of OD-SSBs including the first OD-SSB and a second OD-SSB associated with a second serving cell.

17. The method of claim 15, further comprising:
configuring the OD-SSB to be deactivated after a predefined number of transmissions; and
including an indication of the predefined number of transmissions in the at least one MAC CE.

18. The method of claim 15, further comprising:
generating an information element (IE) for transmission to the UE, wherein the IE is to indicate whether the UE is to use a measurement object (MO) associated with the AO-SSB or an MO associated with the OD-SSB as a reference MO for determining whether a neighbor cell measurement is an intra-frequency measurement or an inter-frequency measurement.

19. The method of claim 15, further comprising:
generating an indication for transmission to the UE to select a measurement object (MO) associated with the AO-SSB as a default reference MO.

20. The method of claim 15, further comprising:
generating an indication for transmission to the UE to enable the UE to autonomously switch between a measurement object (MO) associated with the AO-SSB and an MO associated with the OD-SSB as a reference MO based on UE implementation criteria.
